(19) United States
(12) Patent Application Publication
(10) Pub. No.: US 2026/0213516 A1
(43) Pub. Date: Jul. 23, 2026

(54) INTEGRAL MULTI-MASTER POWER AND COMMUNICATION BUS RAIL SYSTEM

(71) Applicant: ONESUBSEA IP UK LIMITED, London Greater London (GB)

(72) Inventors: Burkhard SOMMER, Houston, TX (US); Hebert HEIDENREICH, Rio de Janeiro (BR); Robert LARGE, Houston, TX (US)

(21) Appl. No.: 19/142,981

(22) PCT Filed: Feb. 20, 2024
(86) PCT No.: PCT/US2024/016533

§ 371 Date: Jun. 25, 2025

Related U.S. Application Data
(60) Provisional application No. 63/486,002, filed on Feb. 20, 2023.

(51) Int. Cl. H02G 9/02; H01B 7/14

(52) U.S. Cl. CPC H02G 9/02; H01B 7/14

(57) ABSTRACT

The disclosed system incorporates an integrated rail power and communication bus system, a superimposed communication signal on a wire pair, inductive couplers for transmission of low power and communication, a redundant multi-master bus system, and a novel multi-material manufacturing method for a power transmission rail system with inductive couplers. The integrated power bus rail may be used on a subsea production system, such as subsea production trees, injection trees, carbon injection trees, manifold and boosting structures and other subsea structures.

### CROSS REFERENCE

This application claims priority to U.S. Provisional Application No. 63/486,002, filed on Feb. 20, 2023, which is hereby incorporated by reference in its entirety.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

For subsea applications, hydrocarbon fluids such as oil and natural gas are obtained from a subterranean geologic formation, referred to as a reservoir, by drilling a well through a subsea wellhead system that penetrates the hydrocarbon-bearing geologic formation.

As the offshore industry increasingly uses electric actuation technologies on subsea structures, there is a need for more electric/electronic interconnectivity between subsea electric and electronic devices. In subsea applications, various types of infrastructure are positioned along a sea floor and coupled by electrical lines. Electric subsea trees and subsea structures require a large quantity of electrical cabling to provide power to subsea control modules, instruments, sensors, electric actuators, wireless modems, and other electric and electronic devices. These devices are usually low power devices and interconnected by electric wires typically housed in oil-filled hoses for pressure balancing, wired in large pressure-compensated oil-filled junction boxes, and terminated at huge and complex subsea mateable electrical connectors with multiple pins. All these components are bulky, difficult to manufacture, costly.

It would thus be helpful to be able to power subsea actuators using reliable, convenient, and powerful power system without the need for electrical cabling or with reduced electrical cabling.

### SUMMARY

This summary is provided to introduce a selection of concepts that are further described below in the detailed description. This summary is not intended to identify key or essential features of the claimed subject matter, nor is it intended to be used as an aid in determining or limiting the scope of the claimed subject matter as set forth in the claims.

According to some embodiments, the present disclosure relates to a subsea equipment having a support surface. The system includes a bus having a plurality of rails coupled to the support surface, wherein the plurality of rails extends along the support surface to form a plurality of loops, wherein the plurality of rails has an electrically conductive material; and wherein the plurality of loops has a plurality of connection areas. Further, the system includes at least one insulating layer disposed over the support surface to insulate the plurality of rails. Further still, the system includes a control module electrically coupled to the bus, wherein the control module is configured to electrically couple to a plurality of subsea components via the plurality of connection areas.

According to some embodiments, the present disclosure relates to a system. The system includes a support surface. The system also includes a bus having a plurality of rails coupled to the support surface, wherein the plurality of rails extends along the support surface to form a plurality of loops, wherein the plurality of rails comprises an electrically conductive material; and wherein the loop has a plurality of connection areas. Further, the system includes at least one insulating layer disposed over the support surface to insulate the plurality of rails. Further still, the system includes a control module electrically coupled to the bus. Even further, the system includes a plurality of inductive couplers disposed on the at least one insulator layer and electrically coupled to the bus.

According to some embodiments, the present disclosure relates to a method. The method includes providing a support surface. The method also includes coupling a bus to the support surface, wherein the bus comprises a plurality of rails, wherein the plurality of rails extends along the support surface to form a plurality of loops, wherein the plurality of rails comprises an electrically conductive material, and wherein the loop comprises a plurality of connection areas. Further, the method includes electrically coupling the bus to a control module, and wherein the control module is configured to electrically couple to a plurality of subsea components via the plurality of connection areas.

### BRIEF DESCRIPTION OF THE DRAWINGS

The subject disclosure is further described in the following detailed description, and the accompanying drawings and schematics of non-limiting embodiments of the subject disclosure. The features depicted in the figures are not necessarily shown to scale. Certain features of the embodiments may be shown exaggerated in scale or in somewhat schematic form, and some details of elements may not be shown in the interest of clarity and conciseness. These and other features, aspects, and advantages of the present invention will become better understood when the following detailed description is read with reference to the accompanying drawings in which like characters represent like parts throughout the drawings, wherein:

FIG. 1 a schematic view of a subsea production system having a subsea power system, according to an embodiment of the present disclosure;

FIG. 2 is a schematic view of the subsea power system of FIG. 1 that includes a bus, according to an embodiment of the present disclosure;

FIG. 3 is a schematic view of the subsea power system of FIG. 1 having a multi-bus configuration, according to an embodiment of the present disclosure;

FIG. 4 is a schematic view of a bus rail support system that may be utilized in the subsea power system of FIG. 1, according to an embodiment of the present disclosure;

FIG. 5 illustrates an electric subsea tree having the bus rail support system of FIG. 4, according to an embodiment of the present disclosure;

FIG. 6 is a cross-sectional of an electric subsea tree having the bus rail support system of FIG. 4, according to an embodiment of the present disclosure;

FIG. 7 is a cross-sectional view of the bus rail support system of FIG. 4 having multiple insulating layers, according to an embodiment of the present disclosure; and

FIG. 8 is a front view of the bus rail support system of FIG. 4 coupled to multiple components, according to an embodiment of the present disclosure.

### DETAILED DESCRIPTION

One or more specific embodiments of the present disclosure will be described below. The particulars shown herein are by way of example, and for purposes of illustrative discussion of the embodiments of the subject disclosure only and are presented in the cause of providing what is believed to be the most useful and readily understood description of the principles and conceptual aspects of the subject disclosure. In this regard, no attempt is made to show structural details of the subject disclosure in more detail than is necessary for the fundamental understanding of the subject disclosure, the description taken with the drawings making apparent to those skilled in the art how the several forms of the subject disclosure may be embodied in practice. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are used in an open-ended fashion, and thus should be interpreted to mean “including, but not limited to.” Also, any use of any form of the terms “connect,” “engage,” “couple,” “attach,” or any other term describing an interaction between elements is intended to mean either an indirect or a direct interaction between the elements described. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. The use of “top,” “bottom,” “above,” “below,” and variations of these terms is made for convenience but does not require any particular orientation of the components.

Certain terms are used throughout the description and claims to refer to particular features or components. As one skilled in the art will appreciate, different persons may refer to the same feature or component by different names. This document does not intend to distinguish between components or features that differ in name, but not function.

The present disclosure relates to a rail support system. In general, the rail support system includes multiple rails that extend along a support surface to form a loop. As such, the loop includes multiple connection areas where electronic devices may be directly coupled to a power supply or controller. In some embodiments, the rail support system may be implemented as a bus rail support system (e.g., bus support system), and the bus (e.g., to provide power and or data) includes the multiple rails that extend along the support surface to form the loop. As such, the loop includes multiple connection areas (e.g., stationary connection areas) wherein electronic devices may be directly or indirectly electrically coupled to the bus. In any case, it should be noted that description of the “bus rail support system” may apply to the “rail support system,” such as the lay out of the rails on the support surface. In some embodiments, the conductive materials may be coupled to one or more inductive couplers. The one or more inductive couplers may thereby provide power between a host structure and an interface to electric and electronic devices. In some embodiments, the bus rail support system may be integrated onto, or otherwise coupled to, subsea equipment (e.g., hydrocarbon production equipment, fluid injection equipment, carbon sequestration equipment, and on one), which may utilize a relatively large number of electronic devices. In this way, the support surface provides modularity for operations where multiple electronic devices are used since the support surfaces may provide a user with various areas to arrange and/or rearrange connected electronic devices.

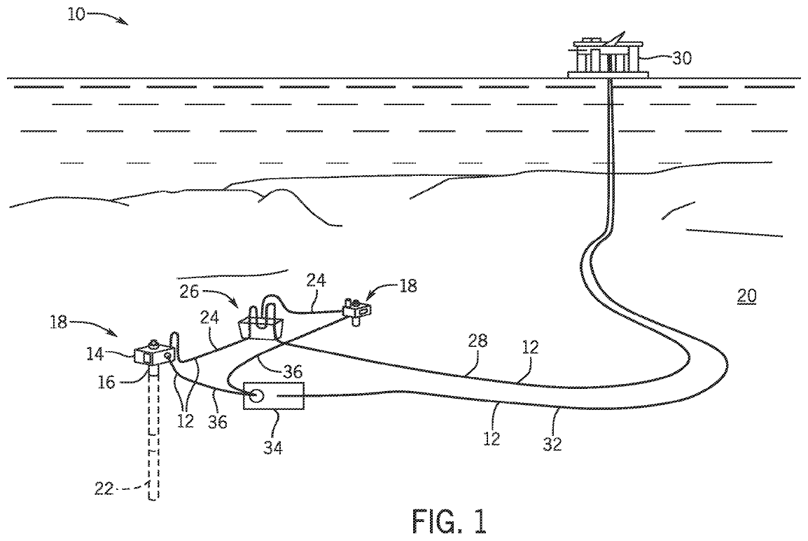

With the foregoing in mind, FIG. 1 is a schematic view of a subsea system 10 with electrical cables 12 used for transmitting information and primary electrical power for various subsea components (e.g., actuators, sensors, etc.). The subsea system 10 may include a subsea hydrocarbon production system configured to extract oil or gas from a subterranean reservoir, a subsea fluid injection system configured to inject fluid (e.g., liquid or gas) into a subterranean reservoir, or any other subsea system associated with subterranean reservoirs. For example, the subsea fluid injection system may include a subsea gas, water, and/or carbon dioxide (CO₂) injection system. In certain embodiments, the subsea system 10 may include a subsea tree 14 coupled to a wellhead 16 to form a subsea station 18 configured to extract and/or inject fluids relative to a subterranean reservoir. For example, the subsea station 18 may be configured to extract formation fluid, such as oil and/or natural gas, from the sea floor 20 through the well 22. By further example, the subsea station 18 may be configured to inject CO₂ into the subterranean reservoir. In some embodiments, the subsea system 10 may include multiple subsea stations 18 that extract and/or inject fluids relative to respective wells 22.

In embodiments of the subsea system 10 configured for production, after passing through the subsea tree 14, the formation fluid flows through fluid conduits or pipes 24 to a pipeline manifold 26. The pipeline manifold 26 may connect to one or more flowlines 28 to enable the formation fluid to flow from the wells 22 to a surface platform 30. In some embodiments, the surface platform 30 may include a floating production, storage, and offloading unit (FPSO) or a shore-based facility. In addition to flowlines 28 that carry the formation fluid away from the wells 22, the subsea system 10 may include lines or conduits 32 that supply fluids, as well as carry control and data lines to the subsea equipment. These conduits 32 connect to a distribution module 34, which in turn couples to the subsea stations 18 via supply lines 36. In some scenarios, the platform 30 may be located a significant distance (e.g., greater than 100 m, greater than 1 km, greater than 10 km, or greater than 60 km) away from the wells 22. As discussed in further detail below, the subsea system 10 (e.g., the subsea tree 14, the subsea station 18, the pipeline manifold 26, and/or the distribution module 34) may include a subsea power system (e.g., subsea power bus system) that provides primary and/or secondary power from energy storage units (e.g., batteries, fuel cells, or super capacitors (for initial actuator movement)) over one or more buses to various subsea components (e.g., actuators, sensors, etc.). For example, the subsea power system may be configured to provide secondary power, such as during a power loss from the primary power from the electrical cables 12, to operate various valves, sensors, and other subsea components. While the subsea system described above is for extracting hydrocarbons, it should be understood that the present disclosure may also apply to other types of subsea systems 10 such as subsea injection systems (e.g., subsea gas injection system, subsea water injection system, subsea carbon dioxide injection system).

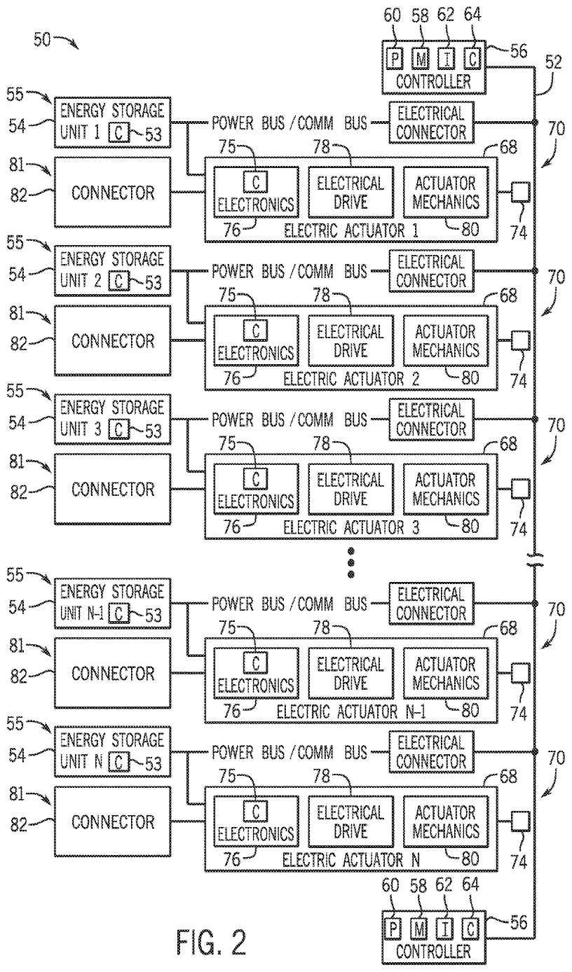

FIG. 2 is a schematic view of an embodiment of the subsea power system 50 coupled to the subsea system 10 of FIG. 1. The subsea power system 50 includes a bus 52 and a plurality of energy storage units 54 electrically coupled to the bus 52 at a plurality of positions 55 distributed throughout the subsea power system 50. The subsea power system 50 is configured to provide electrical power (e.g., primary power and/or secondary power) from the energy storage units 54 over the bus 52 to a plurality of electrical actuators 70 coupled to respective subsea components 74. In certain embodiments, the bus 52 includes an electrical bus and a data bus extending to the plurality of energy storage units 54 and the plurality of electrical actuators 70. The bus 52 may include a network or grid of electrical and/or data cables. The bus 52 may extend over distances of about 5 to 200 meters, or 10 to 100 meters, or another suitable range depending on electrical capacity of the energy storage units 54, power demand of the electrical actuators 70, and electrical losses over the distances. The bus 52 may include one or more of a 24V bus, a 48 bus, a 72V bus, a 96V bus, or a suitable bus 52 between 24V to 800V or 24V to 400V. In certain embodiments, the bus 52 may include multiple power buses 52 of different voltages. The energy storage units 54 may include any suitable number, size, and electrical capacity of batteries, fuel cells (e.g., hydrogen fuel cells), supercapacitors, or any combination thereof. For example, the number, size, and/or electrical capacity of the energy storage units 54 may be based on the number and/or electrical demand of the electrical actuators 70, a factor of safety to ensure redundant and/or excess power supply above the maximum amount needed for the electrical actuators 70, a spatial distribution of the electrical actuators 70 and distances over the bus 52, expected electrical losses over the bus 52, or any combination thereof. The number, size, and/or electrical capacity of the energy storage units 54 are discussed in further detail below.

The subsea power system 50 also includes one or more controller(s) 56. The controller(s) 56 include a memory 58, a processor 60, instructions 62 stored on the memory and executed by the processor 60, and communication circuitry 64. Similarly, each of the energy storage units 54 may include a controller 53 and each of the electrical actuators 70 may include a controller 75, wherein the controllers 53 and 75 may include a processor, memory, instructions, and communication circuitry. The controllers 56, 53, and 75 may operate independently and/or in combination with one another to facilitate control of the subsea power system 50 and operation of the subsea components 74 driven by the electrical actuators 70. For example, the instructions 62, when executed by the processor 60, enable the controller(s) 56 to control the subsea power system 50 to selectively discharge at least one of the plurality of energy storage units 54 over the bus 52 to supply power to at least one of the plurality of electrical actuators 70 coupled to a respective one of the plurality of subsea components 74. The instructions 62, when executed by the processor 60, also enable the controller(s) 56 to control the subsea power system 50 to selectively charge one or more of the plurality of energy storage units 54 over the bus 52 via power from a power supply coupled to the electrical cable 12. The controllers 53 and/or 75 also may provide the same or similar control features as the controllers 56.

In the illustrated embodiment, the subsea power system 50 is electrically coupled to the plurality of electrical actuators 70 via the bus 52, wherein each of the plurality of subsea components 74 is driven by one of the respective plurality of electrical actuators 70. As discussed above, one or more subsea structures or subsea equipment (e.g., subsea tree, manifold, substation, wellhead, etc.) may include the plurality of subsea components 74. The plurality of subsea components 74 may include various flow control equipment, such as valves, pumps, water injection systems, chemical injection systems, or any combination thereof. For example, the subsea components 74 may include a variety of valves, such as gate valves, ball valves, blowout preventers (BOPs), chokes, or any combination thereof. The water and chemical injection systems also may include valves, pumps, flow meters, and other flow control equipment. The subsea components 74 also may include a variety of sensors or monitoring equipment, such as flow meters, temperature sensors, pressure sensors, water sensors, fluid composition sensors, leak sensors, or any combination thereof. However, if the primary power is unavailable when power is needed to operate one or more of the subsea components 74, then the controller(s) 56 selectively controls the subsea power system 50 to provide the secondary power from one or more of the energy storage units 54 over the bus 52 to the appropriate electrical actuators 70 to operate the respective subsea components 74.

Each of the plurality of electrical actuators 70 may include electronics 76, an electrical drive 78, and actuator mechanics 80. The electronics 76 may include power electronics and the controller 75 (e.g., control board, processor, memory, instructions, and communication circuitry). The electrical drive 78 may include a direct current (DC) motor, an alternating current (AC) motor, a servomotor, a linear drive, a rotary drive, or any combination thereof. The actuator mechanics 80 may include a transmission, a gear assembly or gearbox, one or more shafts, a rotary to linear converter, a position lock, a position sensor, or any combination thereof. In certain embodiments, the electric actuators 70 may use electrical power to operate in opposite first and second directions of actuation, such as both clockwise and counterclockwise rotational directions and/or both forward and rearward axial directions. Thus, in an embodiment of the subsea component 74 including a valve, the electrical actuator 70 may be configured to use the electrical power to operate the electric drive 78 for both opening and closing of the valve. In certain embodiments, the electrical actuator 70 may exclude a spring or biasing element configured to bias the actuator in a particular direction, such as spring-biasing the valve toward a normally closed position. Each of the plurality of electrical actuators 70 may also include an interface 81 having one or more connectors 82 for independently coupling with each respective electrical actuator 70. The connectors 82 may include mechanical connectors and electrical connectors, such as stab connectors, rotational connectors, quick connect/disconnect couplings, or a combination thereof. The plurality of electrical actuators 70 may also include integrated harnesses, stab connectors, or a combination thereof, thereby allowing each actuator 70 to be retrievable via a remotely operated vehicle (ROV) via an ROV interface (e.g., the interface 81). In certain embodiments, each of the plurality of energy storage units 54 may be packaged with a corresponding electrical actuator 70 or, in certain embodiments, the plurality of energy storage units 54 may be separate from the plurality of electrical actuators 70. In certain embodiments, the plurality of energy storage units 54 are retrievable (e.g., ROV-retrievable) independently from the plurality of electrical actuators 70. In some embodiments, the plurality of energy storage units 54 and the plurality of electrical actuators 70 are packaged together as packaged unit or module, wherein the module may be retrievable (e.g., ROV-retrievable) or non-retrievable (e.g., fixedly mounted or permanently installed at a subsea structure). In some embodiments, the plurality of energy storage units 54 are retrievable (e.g., ROV-retrievable) while the plurality of electric actuators 70 are non-retrievable (e.g., fixedly mounted or permanently installed at a subsea structure). In the illustrated embodiment, the plurality of energy storage units 54 may be removed and replaced while the subsea power system 50 is in operation (e.g., hot stand-by mode).

In certain embodiments, the subsea system 10 may include an actuation system of the electrical actuators 70 and the energy storage units 54 (e.g., batteries) on the bus 52 of the subsea power system 50 with the below components and features. The actuation system may be based on a 48V power bus system of the subsea power system 50. The actuation system may include dedicated redundant isolated power supplies for battery charging of actuation systems, e.g., energy storage units 54 coupled to electrical actuators 70 over the bus 52. The subsea power system 50 may include a local subsea energy grid for cross-powering of electric consumers, such as the electrical actuators 70. The actuation system may include integrated harnesses and stab connectors at a subsea mounting base and actuator side of the electrical actuators 70. The electrical actuators 70 may include subsea (ROV retrievable) actuators with mechanical and electric quick connect arrangements, or non-subsea retrievable pluggable electric actuators 70 with energy storage units 54 (e.g., batteries).

In certain embodiments, the subsea power system 50 includes the below components and features. The subsea power system 50 may include super capacitors to support high currents during initial phase of motor movements (break-out torque). The super capacitors may have a voltage rating suitable for the bus 52, such as, but not limited to, 24V, 48V, 72V, 96V, or a voltage rating between 24V to 800V or 24V to 400V. The energy storage units 54 (e.g., batteries) can actively be enabled/disabled from discharging, and the energy storage units 54 (e.g., batteries) can actively be removed and replaced while the system is operating.

Considering the size of the subsea production equipment structures, the length of the subsea power system 50 in some embodiments may be around 30-50 meters. In certain embodiments, one may use a 24VDC system to power the bus 52, but it might be a challenge to provide sufficient power from one energy storage unit 54 (e.g., battery) to another electrical actuator 70 over the power bus 52. In certain embodiments, one may use a higher voltage bus 52 that will provide a more effective power transmission. For example, the bus 52 may be rated at a voltage level from approximately 48V, 72V, or 96V up to 400V, 600V, 800V, or higher. In certain embodiments, the expected required maximum current on the power bus 52 might be between 30 A and 65 A.

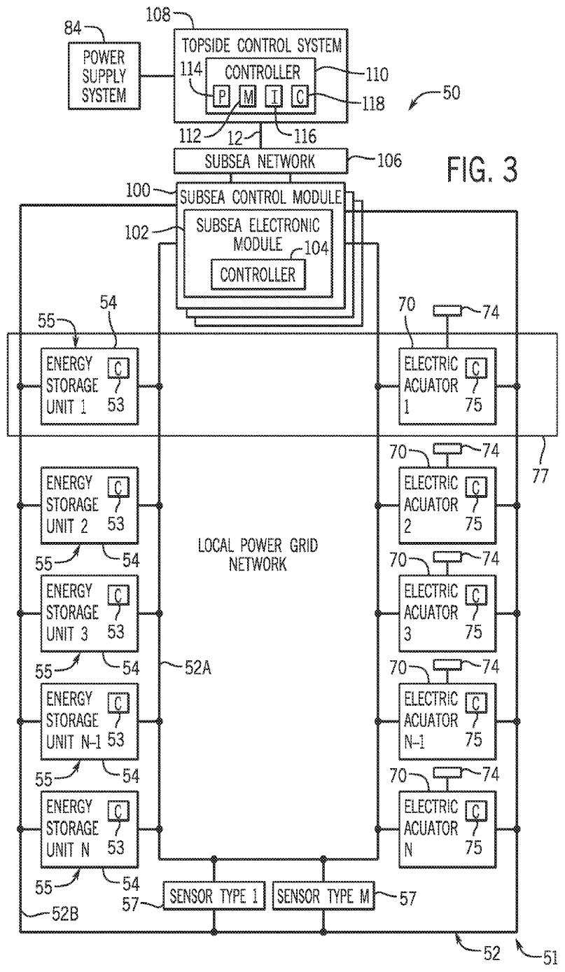

FIG. 3 is a schematic view of an embodiment of the subsea power system 50 coupled to the subsea system 10 of FIG. 1, further illustrating a multi-bus configuration 51 of the bus 52. The subsea power system 50 may include substantially the same features as discussed above with reference to FIG. 2, unless stated otherwise. As illustrated in FIG. 3, the multi-bus configuration 51 has buses 52A and 52B, each coupled to the plurality of energy storage units 54 and the plurality of electrical actuators 70. The buses 52A and 52B may be used as redundant buses 52, independent buses 52 for independent power distribution to different electrical actuators 70, or other bus specific control features operating with multiple buses 50. Although FIG. 3 illustrates two buses 52A and 52B, the multi-bus configuration 51 may include any number of buses 52, such as 2, 3, 4, 5, or more buses 50. The buses 52 (e.g., 52A and 52B) in the multi-bus configuration 53 may include an electrical power bus and a data bus (e.g., monitoring and control data bus). For example, the buses 52 may include a plurality of sensors 57 (e.g., one or more sensor types) coupled to the buses 52A and 52B, wherein the sensors 57 may include voltage sensors, current sensors, or other health monitoring sensors configured to help track a health, a discharge cycle, a charge cycle, or other parameters of the energy storage units 54. The plurality of sensors 57 may include sensor types 1 through M, wherein M is equal to or greater than 1, 2, 3, 4, 5, 6, 7, 8, 9, 10, or more. The monitored data from the sensors 57 is used for monitoring and control of the subsea power system 50 and the subsea system 10 as discussed below.

The subsea power system 50 has the plurality of energy storage units 54 coupled to the buses 52A and 52B at a plurality of positions 55 distributed throughout the subsea power system 50 and the subsea system 10. The plurality of energy storage units 54 may include a plurality of uniformly distributed energy storage units 54 (e.g., uniformly spaced positions 55), a plurality of non-uniformly distributed energy storage units (54 (e.g., non-uniformly spaced positions 55), or a combination thereof. The positions 55 of the energy storage units 54 may be arranged in a three-dimensional space in vertical and horizontal directions. The energy storage units 54 and the electrical actuators 70 may be arranged in pairs in close proximity to one another, as indicated by box 77 (e.g., within 0 to 5 meters). For example, one of the energy storage units 54 may be directly coupled to or mounted on (e.g., integrated into) a respective electrical actuator 70. However, in certain embodiments, the energy storage units 54 may be distributed throughout the bus 52 (e.g., buses 52A and 52B) in a first spatial distribution based on a second spatial distribution of the electrical actuators 70, wherein the first and second spatial distributions are different from one another, and the first spatial distribution is configured to provide an improved distribution of secondary power from the energy storage units 54 to the electrical actuators 70. In operation, the charging and discharging of the energy storage units 54 is controlled by one or more of the controllers 110, 104, 53, and/or 75.

In certain embodiments, the subsea power system 50 includes subsea control module(s) 100 (SCM) coupled to one or more subsea structures (e.g., trees, manifolds, substations, etc.). The subsea power system 50 may include a plurality of the subsea control modules 100 for redundancy and/or independent control of the buses 52A and 52B in the multi-bus configuration 51. The subsea control module(s) 100 may each include a subsea electronic module 102 having a controller 104, such as the controller 56 discussed in detail above with reference to FIG. 2. The subsea power system 50 may also include a subsea network or subsea distribution network 106 (e.g., subsea power and communication distribution network) coupled to the subsea control module(s) 100. The subsea distribution network 106 may include distribution hardware, such as electrical flying leads, subsea umbilicals, umbilical termination units, and subsea distribution modules. The subsea power system 50 may electrically and communicatively couple the subsea distribution network 106 with a topside control system 108 via one or more umbilicals (e.g., electrical cables 12, subsea telecommunication cables). The topside control system 108 is configured to mount on a host structure, such as a surface vessel, a platform, or a marine vessel on the surface of the water. The topside control system 108 includes a controller 110 having a memory 112, a processor 114, instructions 116 stored on the memory 112 and executed by the processor 114, and communication circuitry 118. The topside control system 108 also may couple with a main power supply 84 for supply of the primary power to the subsea system 10. In certain embodiments, the main power supply 84 may not be a single power source, but may also encompass power received via wave energy power buoys, offshore wind turbines, and other electrical power sources. Also, the topside control system 108 may include a combination of an energy harvesting system and a communication buoy using satellite communication between the subsea infrastructure and a remote control location.

The main power supply 84 may include a power generation system, a power grid, or a combination thereof. For example, the power generation system may include one or more electrical generators driven by a combustion engine, such as a gas turbine engine or a reciprocating piston-cylinder engine. The power generation system may include one or more wind turbines, solar panels, hydro turbines, or other power sources. The main power supply 84 is configured to provide the primary power to the subsea system 10 via control by the topside control system 108 (e.g., controller 110) and/or the subsea control modules 100 and via distribution by the subsea distribution network 106. The topside control system 108 (e.g., controller 110) and/or the subsea control modules 100 may be configured to control a primary power supply from the main power supply 84 to the subsea system 10 for operating various subsea components 74 and/or to the subsea power system 50 for charging one or more of the energy storage units 54.

Additionally, the topside control system 108 (e.g., controller 110), the subsea control modules 100 (e.g., controllers 104), the controllers 53 of the energy storage units 54, and/or the controllers 75 of the electric actuators 70 may be configured to monitor operating parameters and control the subsea power system 50 (e.g., charging and discharging of the energy storage units 54) and monitor operating parameters and control the subsea system 10 (e.g., actuation of the subsea components 74, such as opening and closing valves). For example, the controllers 110, 104, 53, and/or 75 may be configured to monitor the health, charge cycles, discharge cycles, and other parameters of the energy storage units 54, monitor availability of the primary power from the main power supply 84, monitor energy demands for powering the electrical actuators 70 to operate the subsea components 74 based on various conditions or events (e.g., pressure exceeds threshold, component failure, emergency closure of valves, etc.) of the subsea system 10, and control the distribution of secondary power from the energy storage units 54 over the bus 52 (e.g., buses 52A and 52B) based on the various monitored parameters. The health of the energy storage units 54 may include electrical charge level, current level and rate of decline in charge level over time, age, historical discharge and charge cycles, historical diagnostic data, operating data during use for powering electrical actuators 70, or any combination thereof. In certain embodiments, the controllers 110, 104, 53, and/or 75 may be configured to communicate with one another in response to various health conditions (e.g., fault, low charge condition, etc.) of the energy storage units 54 to enable an appropriate control response and/or use intervention. For example, the controllers 53 of the energy storage units 54 may enable self-monitoring and reporting of any health conditions to the controllers 104 and/or 110. The controllers 104 and/or 110 also may perform various monitoring of the energy storage units 54, the electrical actuators 70, the buses 52A and 52B, and other aspects of the subsea power system 50. In certain embodiments, in the event of a sensed health condition being a fault, one of the controllers 53, 104, and/or 110 may trigger an isolation or separation control function, thereby isolating or separating the faulty energy storage unit 54 from the bus 52. Additionally, in the event of a sensed health condition being a low charge condition, one of the controllers 53, 104, and/or 110 may trigger a charging cycle, thereby supplying the primary power from the main power supply 84 to the energy storage unit 54 needed a charge. In certain embodiments, the controllers 53 of the energy storage units 54 may communicate with one another, share monitored health information, respond to demands for powering the electrical actuators 70 to operate the subsea components 74, and agree on control actions (e.g., charging cycle to charge one or more energy storage units 54 and/or discharging cycle to provide power from one or more energy storage units 54 over the bus 52). However, any one or a combination of the controllers 110, 104, 53, and/or 75 may be used to provide for monitoring and control of the subsea system 10 and the subsea power system 50 using various control processes as discussed in further detail below.

The subsea power system 50 (e.g., power bus system) can take individual energy storage units 54 (e.g., batteries) and regulate the charging/discharging profile of each energy storage unit 54 (e.g., battery). The subsea power system 50 of the disclosure can “regulate” the electrical energy flow from and to energy storage units 54 (e.g., batteries) and to electric actuators 70. This might happen automatically or with user intervention. The energy storage units 54 (e.g., batteries) might be equipped with intelligent battery firmware, e.g., on controllers 53. In the case of a fault, the energy storage unit 54 (e.g., battery) can send a message to the subsea control module 100 and disables itself if necessary or execute any other pre-programmed algorithms. Any control and status message in relation to the subsea power system 50 might be sent via the subsea control module 100 to the topside control system 108 (e.g., master control station). It is possible to send individual comments from the topside control system 108 to each energy storage unit 54 (e.g., battery) to execute and monitor functions such as battery health, charging cycles, priorities within the grid, assignments between batteries and the electrical actuator(s) 70 they supply. Energy storage units 54 (e.g., batteries) can communicate with other energy storage units 54 (e.g., batteries) to determine identifier numbers and priorities. It is also useful to avoid cross-charging between energy storage units 54 (e.g., batteries). This function can be bypassed by the operator if necessary. In certain embodiments, the subsea power system 50 might be designed in a way that energy flow is only allowed from power supplies located in the subsea control module 100 to the energy storage units 54 (e.g., batteries), from energy storage units 54 (e.g., batteries) to electric actuators 70, from energy storage units 54 (e.g., batteries) to the subsea control module 100 electronic, and/or from energy storage units 54 (e.g., batteries) to subsea sensors 57. Energy flow from energy storage units 54 (e.g., batteries) to energy storage units 54 might be prevented in certain embodiments.

As discussed herein, it may be desirable to power at least a portion of subsea components (e.g., flow control equipment, chemical injection systems, pumps, water injection systems, and the like) with fewer or, in some instance, without electrical cabling. Accordingly, it may be advantageous to utilize a support surface that includes a bus having a loop or otherwise having a sufficient surface area for providing power to multiple subsea components via an electrical connection formed on different areas of the loop. The support surface may reduce the amount of electrical cabling, or even eliminate electrical cabling for certain subsea component, thereby providing more modularity, expandability, and/or reliability to operations using subsea equipment (e.g., wellheads, subsea trees, distribution manifolds, substations, and the like).

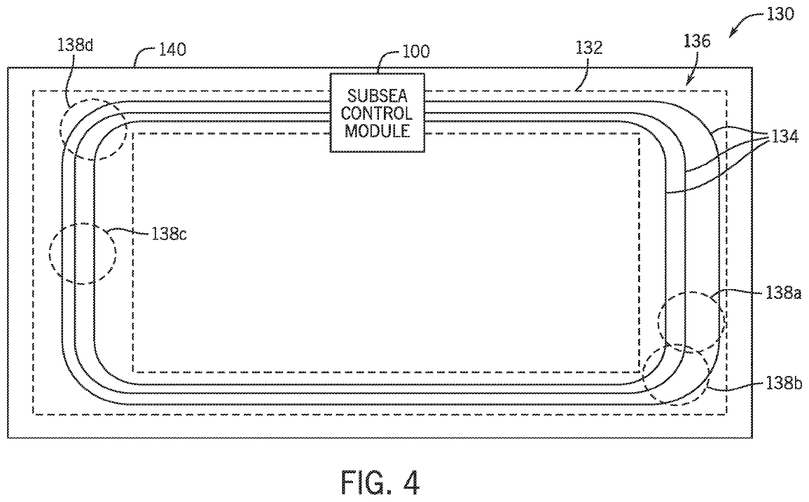

FIG. 4 is a schematic diagram of a bus rail support system 130 (e.g., power bus rail) that generally provides conductive paths along a surface such that multiple electronic devices may couple to the control module via the conductive paths at different connection areas. The bus rail support system 130 includes a bus subsystem 132 (e.g., integral bus rail support system, a bus) that includes rails 134. The rails 134 extend to and from the control module 100 to form loops 136. That is, each rail 134 may extend to form a distinct loop 136 that is electrically coupled to the control module 100. Each loop 136 includes a connection area 138 whereby electrical components may electrically couple, directly or indirectly, to the control module 100. For example, in some embodiments, indirectly electrically coupled may refer to electrically coupling, with one or more intervening electrical components, such as couplers, inductive couplers, and the like. In any case, the loops 136 are coupled to a support surface 140 that generally provides a physical structural support for the electrical components and may be coupled to subsea components, as discussed in further detail herein.

In general, the rails 134 may be formed of (e.g., composed of, consist of, or consist essentially of) one or more conductive materials. As referred to herein, “conductive material” refers to a material having a relatively low restivity, such as having a resistivity at 20° C. less than or equal to 1×10⁻³ ∩·m, less than or equal to 1×10⁻⁴ ∩·m, less than or equal to 1×10⁻⁵ ∩·m, less than or equal to 1×10⁻⁶ ∩·m, or less than or equal to 1×10⁻⁷ ∩·m. For example, the rails 134 may be formed of copper, silver, gold, aluminum, lead, and the like. The rails 134 may be formed on the support surface 140 by various suitable techniques, such as additive manufacturing (e.g., three-dimensional (3D) printing, lithography, and the like), material deposition (e.g., chemical vapor deposition, electrochemical deposition, sputtering, and the like), or otherwise applied to the support surface 140. For example, the rails 134 may be fixedly and/or integrally coupled to the support surface 140 lengthwise along the rails 134 over the support surface 140. By further example, an entire length of each of the rails 134 may be fixedly and/or integrally coupled to the support surface 140. In certain embodiments, the rails 134 may be directly coupled to the support surface 140, such as by directly bonding the conductive material of the rails 134 with the support surface 140. In some embodiments, the rails 134 may be coupled to the support surface 140 via an intermediate layer of adhesive, insulation, or other material. In some embodiments, the rails 134 may be formed along a flat surface (e.g., planar surface) of the support surface 140 and/or the rails 134 may be formed in and extend lengthwise along respective grooves along the support surface 140.

As described above, the rails 134 form loops 136. As shown, the rails 134 has curved corners. In some embodiments, the rails 134 have sharp corners, or a combination of curved and sharp corners. It should be noted that the rails 134 may have any suitable shape, such as rectangular shaped loop (e.g., having sharp corners), circular shaped loop, ovular shaped loop, or an irregular shaped loop. Further, the rails 134 are parallel to one another such that the rails 134 do not overlap. As such, one or more of the loops 136 may be concentric loops (e.g., 2, 3, 4, 5, 6, 7, 8, 9, 10, or more concentric loops). In some embodiments, one or more of the rails 134 may overlap. For example, the rails 134 of a first loop 136 may cross over the rails 134 of a second loop 136 one or more positions or locations along the respective loops 136. In such embodiments, the rails of the first loop 136 and the rails 134 of the second loop 136 may be separated by a suitable insulating material (e.g., electrically insulating layer) to prevent cross-talk or electrical coupling between the first loop 136 and the second loop 136.

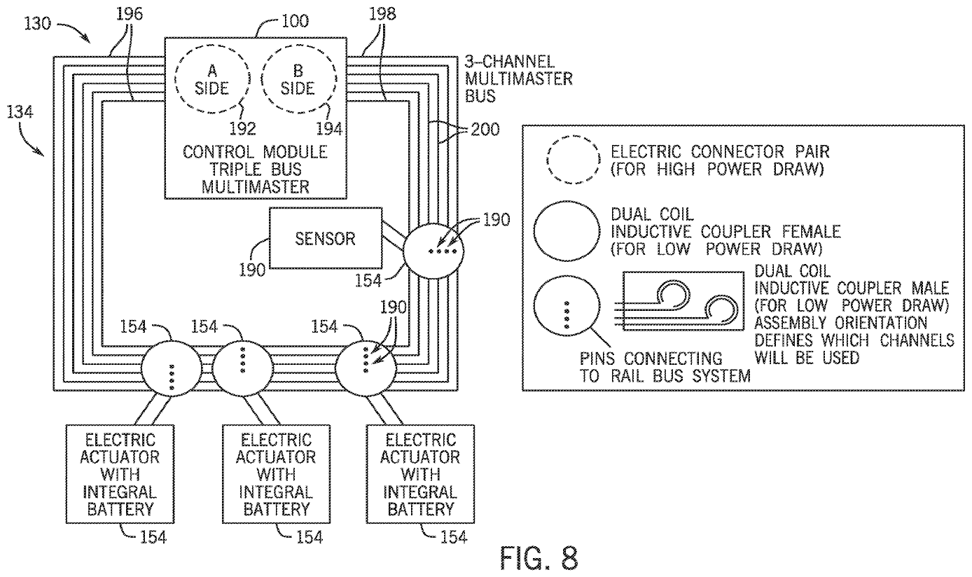

In certain implementations, the support surface 140 may be coupled to or an integral part of subsea equipment, such as a subsea tree, a well, a manifold, a subsea station, or the like. For example, the support surface 140 may include a surface of a framework, a housing, a wall, a floor, a ceiling, a structural support member, or any combination thereof, of the subsea equipment. By further example, the support surface 140 may be an integral surface of the subsea equipment, wherein the subsea equipment is constructed with one or more metals suitable for a subsea environment. Thus, the support surface 140 may be a rigid support surface that provides rigidity to the rails 134 in the loops 136 coupled to the support surface 140, thereby structurally supporting and protecting the rails 134 in the loops 136. In contrast to flexible cables, the support surface 140 completely protects the rails 134 in the loops 136 on at least the side of the support surface 140. Additionally, the support surface 140 may provide a surface area where one or more subsea components may be electrically coupled to the control module 100 at the different connection areas 138, but with a reduced amount of wiring to provide power to the one or more subsea components. For example, a first subsea component (e.g., a sensor) may be coupled to a first connection area 138, and a second subsea component (e.g., an electrical actuator) may be electrically coupled to a second connection area 138. In some embodiments, one or more couplers, such as inductive couplers, may be coupled to each connection area 138. As described in more detail with respect to FIG. 8, providing the inductive couplers may provide modularity to the support surface 140 by making it easier for a user to swap, alter, or otherwise adjust the connection area 138 for a particular subsea component. For example, it may be advantageous to alter connection areas 138 for different subsea components based on an available space on a particular connection area 138 to support a particular subsea component.

In some embodiments, the support surface 140 may be a rigid, substantially planar surface. For example, the support surface 140 may be formed of a substantially rigid material having a Youngs's Modulus that is greater than or equal to 100 Mega Pascals (MPa), greater than or equal to 250 MPa, greater than or equal to 500 MPa, greater than or equal to 750 MPa, greater than or equal to 1000 MPa, and so on. In some embodiments, the insulating material may include rubber, insulating polymers (e.g., polytetrafluoroethylene (PTFE), polyethylene terephthalate (PTE), and the like). In any case, it may be advantageous such that at least one insulating layer is provided on the support surface 140 to provide electrical insulation for the conductive material of the rails 134. For example, a first insulating layer may be provided on a top surface of the support surface 140. In some embodiments, the support surface 140 may be formed using the insulating material. In some embodiments, the support surface 140 may be formed around the loops 136. For example, the support surface 140 may be an insulating polymer that is cured while the loops 136 are provided within the uncured insulating polymer.

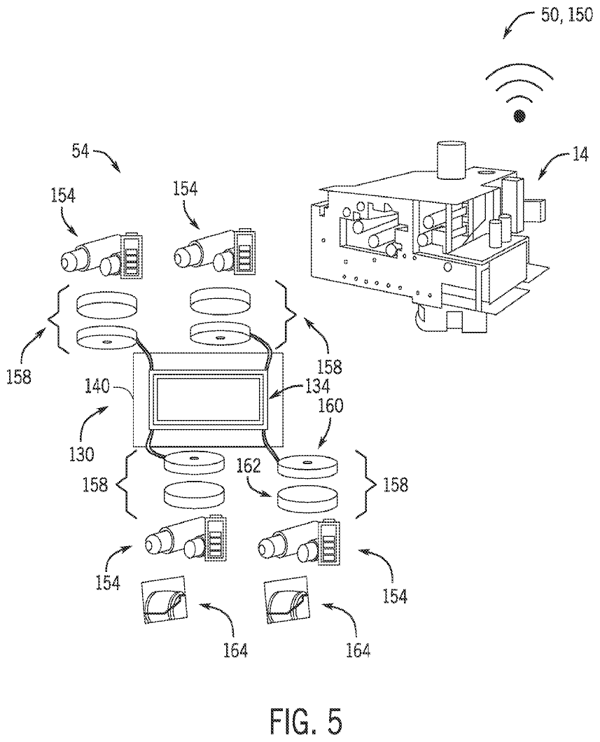

In any case, by forming the support surface 140 having the rails 134, electric or electrical devices may be coupled to the rails 134 at one or more connection areas 138. In this way, the bus rail support system 130 may reduce a likelihood of crossing or tangling cables that may be used in conventional subsea trees for electrically coupling electric or electrical devices to power. As noted herein, although the above description relates to a bus rail support system, the description of FIG. 4 may also apply to a rail support system. Further, the descriptions of FIGS. 5-8 may also apply to the rail support system.

As discussed herein, the bus rail support system 130 may be coupled to subsea equipment, such as a subsea tree, a well, a manifold, a subsea station, or the like. To illustrate this, FIG. 5 shows an example subsea power system 50 or subsea equipment system 150 that includes electric subsea tree 14 having a bus rail support system 130. In particular, the subsea equipment system 150 includes the electric subsea tree 14 coupled to the bus rail support system 130 that provides power to electric actuators 154. In general, the electric actuators 154 may include similar components as described with respect to the electric actuators 68 of FIG. 2. For example, the electric actuators 154 may include the electronics 76 and the electrical drive 78. As shown, the electric actuators 154 include an energy storage 54. In some embodiments, the energy storage 54 may be an integrated battery (e.g., integral battery) that manages power to the electric actuators 154. As described herein, including the integrated battery may advantageously manage current flowering through the rails 134.

As shown, the electric actuators 154 are electrically coupled to the bus rail support system 130 via an inductive coupler 158. The inductive couplers 158 may be coupled to the bus rail support system using flexible connections (e.g., copper wires with coatings) or a rigid connection such that the inductive coupler 158 is in a substantially fixed position. Each inductive coupler 158 includes a male coupling portion 160 (e.g., dual coil male portion) and a female coupling portion 162 (e.g., a dual coil female portion). The male coupling portion 160 and the female coupling portion 162 may be selectively couplable with the male coupling portion 160 or the female coupling portion 162 of other inductive couplers 158. For example, subsea components coupled to one portion (e.g., the male coupling portion 160) may be arranged to couple with the complementary portion (e.g., the female coupling portion 162) disposed in different connection areas 138. The male coupling portion 160 may be coupled to the female coupling portion 162 when provided in a mated position. In some embodiments, the male coupling portion 160 includes pins that when in a mated position with the female coupling portion 162 are disposed through the at least one insulator layer and in contact with the plurality of rails 134.

In any case, the electric actuators 154 may provide power to valves 164. In general, the valves 164 may be any suitable valve of the subsea tree 14, such as low friction valves, master valves, wing valves, swab valves, flowline isolation valves, chemical injection valves, downhole isolation valves. However, it should be noted that the electric actuators 154 may be used to actuate various components or equipment on the subsea tree 14 as described herein, such as chokes, pressure transmitters, sand detectors, vibration sensors, and flow meters.

The electric tree 14 may consume ultra-low power (e.g., 10-200 Watts). The bus rail support system 130 is disposed on the electric tree 14 and provides power to the various components and equipment without the need for any pressure compensated oil-filled hoses housing 24 electrical cables. The electric tree 14 further comprises a plurality of electric actuators 154 having integral batteries 54 that are in electrical communication with the bus rail support system 130 via the inductive couplers 158. The electric actuators 154 may be used to actuate various components or equipment on the electric tree including, but not limited to, low friction valves, master valves, wing valves, swab valves, flowline isolation valves, chemical injection valves, downhole isolation valves, chokes, pressure transmitters, sand detectors, vibration sensors, and flow meters. To reduce the amount of power to be transferred over the inductive couplers 158, it may be advantageous to provide batteries for trickle-charge in the device housings. That is, it is presently recognized that providing the batteries may be useful in cases where devices have occasional high-power consumption to regulate current within a threshold range. While the embodiment in FIG. 5 is shown with inductive couplers 158, any other suitable coupler may be used in other embodiments, such as electric connectors.

While only a single support surface 140 is shown, it should be noted that the bus rail support system 130 may include multiple support surfaces 140. Each support surface 140 may be electrically coupled to one another. Further, each support surface 140 may be arrange at any angle such that the support surfaces 140 are perpendicular, co-planar, angularly offset, and so on, to another support surface 140.

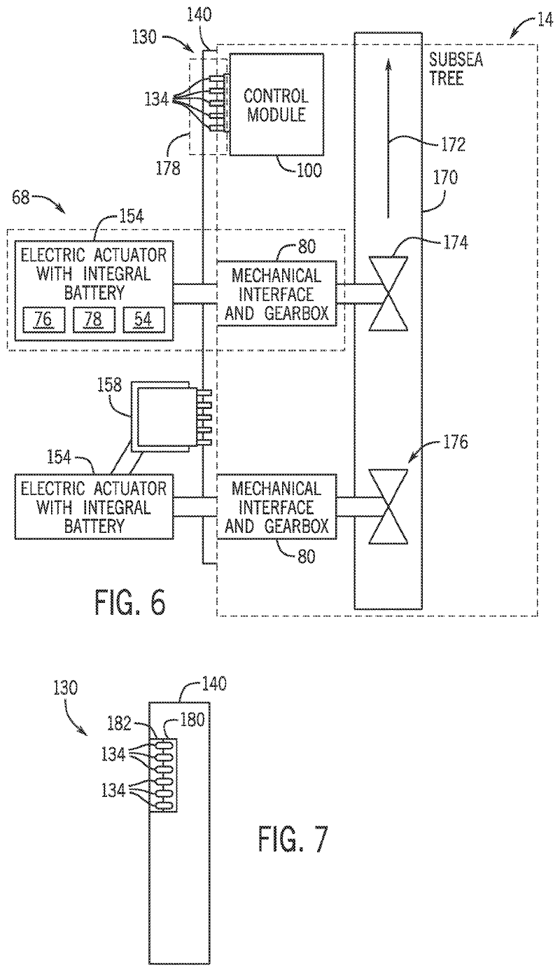

In some embodiments, the bus rail support system 130 may be coupled to subsea equipment with one or more integrated subsea components, such as valves. To illustrate this, FIG. 6 is a cross-sectional view of a subsea tree 14 having a bus rail support system 130 with a control module 100. In the illustrated embodiment, the electric subsea tree 14 includes conduit 170 that may provide a production flow path 172 to hydrocarbon fluids such as oil and natural gas. As shown, the production flow path 172 is in an upwards direction that corresponds to a direction from wells (e.g., the wells of FIG. 1) to a surface platform (e.g., surface platform 30 of FIG. 1). However, in some embodiments, the conduit 170 may be used to inject fluids into a subterranean formation.

The subsea tree 14 includes a swab valve 174 and a master valve 176. However, it should be noted that these valves (e.g., the swab valve 174 and the master valve 176) are meant to be non-limiting examples of subsea components. For example, the subsea tree 14 may include other fluid flow devices, fluid injection systems, and other components described herein. In any case, operation of the swab valve 174 and the master valve 176 are controlled using the actuator mechanics 80 (e.g., the mechanical interface and gearbox). In general, the actuator mechanics 80 may include generally similar features as described with respect to FIG. 2.

In the illustrated embodiment, the actuator mechanics 80 of the master valve 176 is controlled by an electric actuator 154. The electric actuator 154 is coupled to the rails 134 via an inductive coupler 158. Accordingly, a position of the master valve 176 may be adjusted to an open position or a closed position by the control module 100 via power supplied through the inductive coupler 158. In general, the electrical actuator 154 may include certain features of the electric actuator 68 described in FIG. 2. For example, and as shown, the electrical actuator 154 may include electronics 76, an electrical drive 78, and an energy storage 54.

In the illustrated embodiment, the actuator mechanics 80 of the swab valve 174 is controlled by an electric actuator 154. The electric actuator 154 is directly electrically coupled to the rails 134. Accordingly, a position of the swab valve 174 may be adjusted to an open position or a closed position by the control module 100 via the direct electrical coupling of the electric actuator 154 to the rails 134.

As described herein, the bus rail support system 130 may include at least one insulating layer (e.g., electrically insulating layer). To illustrated this, FIG. 7 shows a cross-sectional view of an example of the bus rail support system 130 corresponding to the area 178 shown in FIG. 6. In particular, the enlarged view of the portion of the bus rail support system 130 shows a cross-sectional view of the bus rail support system 130 (e.g., multimaster bus), which comprises a plurality of rails 134 (e.g., electrical conductors or conductive paths) disposed between (e.g., sandwiched between) an upper or outer layer insulating layer (e.g., top insulating layer 182) and a lower or inner layer insulating layer (e.g., bottom insulating layer 180). The bottom insulating layer 180 and the top insulating layer 182 surround the rails 134, such that pins of any connector pierce the upper layer insulating to connect to any of the rails 134. In other words, the bottom insulating layer 180 extends directly along (e.g., parallel with) the support surface 140, the plurality of rails 134 extend over the bottom insulating layer 180, and the top insulating layer 182 extends directly along (e.g., parallel with) the bottom insulating layer 182 over the plurality of rails 134. In some embodiments, the rails 134 may be formed within a groove of the insulating layers.

As shown, the rails 134 are coated with a bottom insulating layer 180 and a top insulating layer 182 on the support surface 140. In general, the bottom insulating layer 180 and the top insulating layer 182 may be made of any suitable electrically non-conductive material including, but not limited to, polymeric and ceramic materials. In one embodiment, one insulating material that encases the rails 134 may be used instead of the bottom insulating layer 180 and the top insulating layer 182. In an embodiment, a coil may also be integral to the power bus rail panel and located between the bottom insulating layer 180 and the top insulating layer 182 and between two conductors. In one embodiment, the inductive coupler 158 and rails may be manufactured using novel manufacturing methods, such as additive manufacturing or 3D printing methods. The conductors may be made of any suitable conductive material including, but not limited to, copper and aluminum. As described in more detail below, electronic components may include pins that penetrate through one or more of the insulating layers (e.g., including the top insulating layer 182), and thereby coupling to the rails 134.

Certain embodiments of the disclosure are directed to a method of forming the bus rail support system 130, such as forming the support surface 140 and/or connecting the electrical components described herein to the support surface 140. The process may include providing a support surface 140. The process may also include coupling a bus (e.g., the bus subsystem 132) to the support surface 140. As described herein, the bus includes a plurality of rails 134 and the plurality of rails 134 extends along the support surface 140 to form a plurality of loops. The plurality of rails 134 includes an electrically conductive material, and the loop includes a plurality of connection areas. Further, the process may include electrically coupling the bus to a control module 100. As described herein, control module 100 is configured to electrically couple to a plurality of subsea components via the plurality of connection areas.

To further illustrate embodiments of the present disclosure, FIG. 8 shows a perspective view of the bus rail support system 130 with inductive couplers 158 that electrically couple certain electronic devices to the rails 134, and ultimately, the control module 100. As shown, the bus rail support system 130 includes multiple rails 134, sensors 190, inductive couplers 158, and electric actuator 154. In some embodiments, the rails 134 may be paired, such that each pair makes an electric channel between a first side 192 and a second side 194 of the control module 100. In the illustrated embodiment, the bus rail support system 130 is a three-channel multimaster bus that comprises three bus pairs. For example, the bus rail support system 130 includes a first bus pair 196, a second bus pair 198, and a third bus pair 200 that may be used for both power and 28 communication. The first bus pair 196 (e.g., a first auxiliary bus pair) includes the two outermost rails 134, the second bus pair 198 (e.g., a main bus pair) includes the two conductors disposed inward of the first bus pair 196, and the third bus pair 200 (e.g., a second auxiliary bus pair) includes the two innermost conductors. While the bus rail support system 130 in FIG. 8 is a three-channel bus, any number of channels may be used, for example a one-or two channel bus may be used or a four-, five-, six-, seven-, eight-, nine-, ten-, eleven-, twelve-channel or more bus may be used.

The bus rail support system 130 may use an alternating current (AC) supply system and be connected on the two sides (e.g., the first side 192 (e.g., A side) and the second side 194 (e.g., B side)) to the control module 100 with multi-master capability. In some embodiments, the control module 100 may include a diplexer and a signal modulator to superimpose communication over the AC power signal.

The bus rail support system 130 may include an electric connector pair (e.g., male and female electrical connectors) for high power draws. For lower power draws, inductive couplers are used for power transmission. Sensors and electric actuators for valves (e.g., master valve, swab valve, wing valve, etc.) may be powered by the power bus rail system via inductive couplers. Each device to be powered by the power bus rail system will have a unique identifier/address for receiving commands from the control module. Each device may have a central processing unit (CPU), read-only memory (ROM), and random-access memory (RAM) that is configured to detect the bus state and execute a pre-programmed workflow to respond to any power, communication, or power and communication issues. Each device may also include electronics to separate power and communication from the induced signal. Each device may be equipped with the feature to feed power back to the rail system if needed.

A wide range of devices may be supported including, but not limited to, electric actuators, flow measurement devices, pressure and temperature sensors, leak detectors, vibration sensors, acoustic sensors, optical devices, long-distance communication devices, wireless modems, downhole equipment, data loggers etc.

Each inductive coupler 158 comprises a dual coil female portion and a dual coil male portion. In some embodiments, the inductive coupler 158 may include pairs of first and second coil portions. For example, the first and second coil portions may include (i) a single coil female portion and a single coil male portion, (ii) a dual coil female portion and a dual coil male portion, or a combination thereof. In any case, each male induction coupler portion has at least two coils making a channel, one connected to the central main bus and one to an outer auxiliary bus via pins 202. The outer auxiliary bus may be selected for improved reliability and channel isolation based on the assembly orientation-the position of the pins 202 defines which coils/channels of the multimaster bus will be used. For example, the sensor and the master valve actuator each have inductive coupler male portions comprising two pairs of pins 202—two disposed in alignment with the second bus pair 198 (e.g., main bus) and two disposed in alignment with the third bus pair 200 (auxiliary 2 bus). The swab and wing valves each also have inductive coupler male portions comprising two pairs of pins 202—two disposed in alignment with the second bus pair 198 (main bus) and two disposed in alignment with the first bus pair 196 (e.g., auxiliary 1 bus). While the embodiment in FIG. 8 is shown with an inductive couplers male portion having two pins, it should be noted that other pin quantities may be used including, but not limited to, three pins, four pins, five pins, or more. In some instances, there may be electronic devices that only access one bus, while in other instances, there may be electronic devices that can access more than one bus. For example, the electronic device coupled to the bus rail support system 130 may be electrically coupled to the first bus pair 196, the second bus pair 198, the third bus pair 200, or any combination thereof.

While the embodiment in FIG. 8 is shown with inductive couplers 158, any other suitable coupler may be used in other embodiments, such as electric connectors (e.g., male and female electrical connectors). Electric connectors may be used if a power draw from the host control module is high. The power draw will be expected to be distributed through the devices connected to a bus via the rails 134. For example, if each device draws 40 Watts per coil and eight devices are active and demanding power from the bus (e.g., charging the internal battery of the connected device), the control module 100 will deliver at least 320 Watts to the bus rail support system 130. This power may be distributed in a balanced way over the bus system to avoid high electrical loads on one bus, while other buses (e.g., the first bus pair 196, the second bus pair 198, or the third bus pair 200) are in an idle state.

Whether inductive couplers 158, electric connectors (e.g., male and female electrical connectors), or another type of connector is used, the mating connections are made on land before the electric subsea tree 14 is installed on a subsea equipment (e.g., subsea tree, wellhead, substation, manifold, etc.). During installation, the pins of the inductive coupler male portions penetrate the upper layer insulating (e.g., shown in FIG. 7) of the bus rail support system 130 to make contact with the conductors of the rails 134. It should be noted that, in some instances, the subsea components may be subsea retrievable components through a remotely operated vehicle (ROV) in embodiments where inductive couplers 158 are used for at least a portion of the subsea components, or where the inductive couplers omitted. Accordingly, embodiments of the disclosure may include retrieving a first subsea component having a connector (e.g., a male or female electrical connector) and replacing the first subsea component with a second subsea component that has a similar connect (e.g., a male or female electrical connector). Additionally or alternatively, the ROV may be used to swap or exchange the positions of the subsea components on the support surface 140. In this way, the bus rail support system 130 may provide modularity and flexibility for subsea operations and reducing a need for removing a large number of subsea components from the ocean floor.

The disclosed system incorporates an integrated rail power and communication bus system, a superimposed communication signal on a wire pair, inductive couplers for transmission of low power and communication, a redundant multi-master bus system, and a novel multi-material manufacturing method for a power transmission rail system with inductive couplers. The integrated power bus rail may be used on a subsea production system, such as subsea production trees, injection trees, carbon injection trees, manifold and boosting structures and other subsea structures. The disclosed system de-risks and eliminates the time-intensive mate and de-mate process of electrical connections. The disclosed system further provides high reliability in a compact design along with reduced equipment and manufacturing costs and a significant reduction in complex wiring schemes.

The subject matter described in detail above may be defined by one or more clauses, as set forth below.

A system includes subsea equipment having a support surface. The system also includes a bus comprising a plurality of rails coupled to the support surface, wherein the plurality of rails extends along the support surface to form a plurality of loops, wherein the plurality of rails comprises an electrically conductive material; and wherein the plurality of loops comprises a plurality of connection areas. Further, the system includes at least one insulating layer disposed over the support surface to insulate the plurality of rails. Further still, the system includes a control module electrically coupled to the bus, wherein the control module is configured to electrically couple to a plurality of subsea components via the plurality of connection areas.

The system of any preceding clause, further comprising one or more inductive couplers electrically coupled to a portion of the plurality of connection areas.

The system of any preceding clause, wherein rails of the plurality of rails are parallel to one another.

The system of any preceding clause, wherein the plurality of loops comprises a circular shaped loop, a rectangular shaped loop, an ovular shaped loop, an irregular shaped loop, or a combination thereof.

The system of any preceding clause, wherein the plurality of subsea components comprises one or more electric actuators.

The system of any preceding clause, wherein the one or more electric actuators comprise an integral battery.

The system of any preceding clause, wherein the subsea components comprise one or more valves, wherein the one or more electric actuators are configured to adjust a position of the one or more valves.

The system of any preceding clause, wherein the plurality of subsea components is coupled to the subsea equipment.

The system of any preceding clause, wherein the plurality of subsea components comprises at least one of flow control equipment, subsea fluid injection systems, pumps, or a combination thereof.

The system of any preceding clause, wherein the subsea equipment comprises at least one of a wellhead, a subsea tree, a distribution manifold, a substation, or a combination thereof.

The system of any preceding clause, wherein the at least one insulating layer comprises a first insulating layer integrally formed on the support surface over the plurality of rails.

A system includes a support surface. The system also includes a bus comprising a plurality of rails coupled to the support surface, wherein the plurality of rails extends along the support surface to form a plurality of loops, wherein the plurality of rails comprises an electrically conductive material, and wherein the loop comprises a plurality of connection areas. Further, the system includes at least one insulating layer disposed over the support surface to insulate the plurality of rails. Further still, the system includes a control module electrically coupled to the bus. Even further, the system includes a plurality of inductive couplers disposed on the at least one insulator layer and electrically coupled to the bus.

The system of any preceding clause, wherein the plurality of inductive couplers comprises a plurality of pairs of first and second coil portions that mate with one another.

The system of any preceding clause, wherein the plurality of pairs of first and second coil portions comprises a dual coil female portion and a dual coil male portion, wherein the dual coil male portion includes a plurality of pins that when in a mated position are disposed through the at least one insulator layer and in contact with the plurality of rails.

The system of any preceding clause, wherein the support surface comprises a rigid, substantially planar surface.

The system of any preceding clause, wherein the support surface is coupled to a subsea tree.

The system of any preceding clause, further comprising a plurality of sensors, actuators, or a combination thereof, electrically coupled to the plurality of rails via the plurality of inductive couplers.

A method includes providing a support surface. The method also includes coupling a bus to the support surface, wherein the bus comprises a plurality of rails, wherein the plurality of rails extends along the support surface to form a plurality of loops, wherein the plurality of rails comprises an electrically conductive material; and wherein the loop comprises a plurality of connection areas. Further, the method includes electrically coupling the bus to a control module, and wherein the control module is configured to electrically couple to a plurality of subsea components via the plurality of connection areas.

The method of any preceding claim, further comprising coupling a plurality of inductive couplers to the plurality of connection areas.

The method of any preceding claim, wherein providing the support surface coupled to the plurality of rails comprises forming an insulator layer on the plurality of rails.

The above discussion is meant to be illustrative of the principles and various embodiments of the present disclosure. While certain embodiments have been shown and described, modifications thereof can be made by one skilled in the art without departing from the spirit and teachings of the disclosure. The embodiments described herein are exemplary only and are not limiting. Accordingly, the scope of protection is not limited by the description set out above, but is only limited by the claims which follow, that scope including all equivalents of the subject matter of the claims.

What is claimed is:

1. A system, comprising:
subsea equipment having a support surface;
a bus comprising a plurality of rails coupled to the support surface, wherein the plurality of rails extends along the support surface to form a plurality of loops, wherein the plurality of rails comprises an electrically conductive material; and wherein the plurality of loops comprises a plurality of connection areas;
at least one insulating layer disposed over the support surface to insulate the plurality of rails; and
a control module electrically coupled to the bus, wherein the control module is configured to electrically couple to a plurality of subsea components via the plurality of connection areas.

2. The system of claim 1, further comprising one or more inductive couplers electrically coupled to a portion of the plurality of connection areas.

3. The system of claim 1, wherein rails of the plurality of rails are parallel to one another.

4. The system of claim 1, wherein the plurality of loops comprises a circular shaped loop, a rectangular shaped loop, an ovular shaped loop, irregular shaped loop, or any combination thereof.

5. The system of claim 1, wherein the plurality of subsea components comprises one or more electric actuators.

6. The system of claim 5, wherein the one or more electric actuators comprise an integral battery.

7. The system of claim 5, wherein the subsea components comprise one or more valves, wherein the one or more electric actuators are configured to adjust a position of the one or more valves.

8. The system of claim 1, wherein the plurality of subsea components is coupled to the subsea equipment.

9. The system of claim 1, wherein the plurality of subsea components comprises at least one of flow control equipment, subsea fluid injection systems, pumps, or a combination thereof.

10. The system of claim 1, wherein the subsea equipment comprises at least one of a wellhead, a subsea tree, a distribution manifold, a substation, or a combination thereof.

11. The system of claim 1, wherein the at least one insulating layer comprises a first insulating layer integrally formed on the support surface over the plurality of rails.

12. A system, comprising:
a support surface;
a bus comprising a plurality of rails coupled to the support surface, wherein the plurality of rails extends along the support surface to form a plurality of loops, wherein the plurality of rails comprises an electrically conductive material; and wherein the loop comprises a plurality of connection areas;
at least one insulating layer disposed over the support surface to insulate the plurality of rails;
a control module electrically coupled to the bus; and
a plurality of inductive couplers disposed on the at least one insulator layer and electrically coupled to the bus.

13. The system of claim 12, wherein the plurality of inductive couplers comprises a plurality of pairs of first and second coil portions that mate with one another.

14. The system of claim 13, wherein the plurality of pairs of first and second coil portions comprises a dual coil female portion and a dual coil male portion, wherein the dual coil male portion includes a plurality of pins that when in a mated position are disposed through the at least one insulator layer and in contact with the plurality of rails.

15. The system of claim 12, wherein the support surface comprises a rigid, substantially planar surface.

16. The system of claim 12, wherein the support surface is coupled to a subsea tree.

17. The system of claim 12, further comprising a plurality of sensors, actuators, or a combination thereof, electrically coupled to the plurality of rails via the plurality of inductive couplers.

18. A method, comprising:
providing a support surface;
coupling a bus to the support surface, wherein the bus comprises a plurality of rails, wherein the plurality of rails extends along the support surface to form a plurality of loops, wherein the plurality of rails comprises an electrically conductive material; and wherein the loop comprises a plurality of connection areas; and
electrically coupling the bus to a control module, and wherein the control module is configured to electrically couple to a plurality of subsea components via the plurality of connection areas.

19. The method of claim 18, further comprising coupling a plurality of inductive couplers to the plurality of connection areas.

20. The method of claim 18, wherein providing the support surface coupled to the plurality of rails comprises forming an insulator layer on the plurality of rails.
